(19) United States
(12) Patent Application Publication
(10) Pub. No.: US 2024/0354056 A1
(43) Pub. Date: Oct. 24, 2024

(54) MICROPROCESSOR WITH FLOATING-POINT CORDIC INSTRUCTIONS

(71) Applicant: STMicroelectronics International N.V., Geneva (CH)

(72) Inventors: Pierre Gobin, Seyssinet-Pariset (FR); Jeremy Ribeiro De Freitas, Coublevie (FR)

(21) Appl. No.: 18/305,869

(22) Filed: Apr. 24, 2023

(51) Int. Cl. G06F 7/485; G06F 5/01; G06F 7/556

(52) U.S. Cl. CPC G06F 7/485; G06F 5/012; G06F 7/556

(57) ABSTRACT

A circuit for computing sine and cosine of an angle iteratively includes: a counter; an angle updating circuit configured to compute, for each iteration, an updated value of the angle; and a coordinate updating circuit including: a first register for storing a cosine value; a second register for storing a sine value; and a first custom floating-point adder/subtractor (CFPAS) circuit and a second CFPAS circuit having a same structure, where an output of the first register and an output of the second register are coupled to a first input terminal and a second input terminal of the first CFPAS circuit, and are coupled to a second input terminal and a first input terminal of the second CFPAS circuit, where an output of the counter is coupled to a third input terminal of the first CFPAS circuit and a third input terminal of the second CFPAS circuit.

### TECHNICAL FIELD

The present invention relates generally to circuits, in particular embodiments, to circuits for implementing floating-point Coordinate Rotation Digital Computer (CORDIC) algorithm.

### BACKGROUND

In many applications (e.g., motor control applications), conversion between a polar coordinate system and a Cartesian coordinate system is required. To convert a vector in a polar coordinate system into an x-coordinate and a y-coordinate in a Cartesian coordinate system, computation of r×cos(α) and r×sin(α) needs to be performed, where r is the length of the vector, and a is the angle of the vector.

The CORDIC algorithm is an iterative algorithm that can be used for performing the conversion between the polar coordinate system and the Cartesian coordinate system. The CORDIC algorithm may also be used for computing sine and cosine functions for a specific angle α, e.g., by setting r=1 in the conversion between the polar coordinate system and the Cartesian coordinate system. By limiting the rotational angle in each iteration of the CORDIC algorithm to arctan

$$( \frac{1}{{2}^{i}} ) ,$$

where i=0, 1, 2, . . . , n−1 is the index of iteration, the only multiplication used in the CORDIC algorithm involves multiplying a multiplicand with a multiplier of 2⁻ⁱ, which may be efficiently implemented in hardware by, e.g., shifting the multiplicand to the right-hand side by a total of i bits when the multiplicand is an integer number.

Currently, in order to provide support for CORDIC function for a processor (e.g., a central processing unit (CPU) such as an ARM core), a co-processor is often used to implement the CORDIC function. To compute the CORDIC function, the processor issues a command for computing the CORDIC function, which command is sent to the co-processor for processing. The results computed by the co-processor is then send back to the processor. The overhead related with the communication between the processor and the co-processor reduces the efficiency of the system. In addition, circuits for implementing the CORDIC function typically use integer representation for the values, which further reduces the efficiency and causes more burden for the processor, because the processor may need to convert the floating-point numbers (e.g., used in the processor) into integer representation for use in the co-processor, and may need to convert the retrieved results (e.g., integer numbers) from the co-processor back into floating-point numbers. There is a need in the art for a processor that has a built-in (e.g., integrated on a same semiconductor die with the processor) CORDIC circuit that supports floating-point CORDIC function computations.

### SUMMARY

In an embodiment, a circuit for computing floating-point sine and cosine functions iteratively through multiple iterations includes: a counter configured to be incremented by one after each iteration; an angle updating circuit configured to be initialized with an initial value for an angle and configured to compute, for each iteration, an updated value of the angle based on a current value of the angle and a pre-determined rotation angle for each iteration; and a coordinate updating circuit comprising: a first register for storing a value corresponding to the cosine function; a second register for storing a value corresponding to the sine function; and a first custom floating-point adder/subtractor circuit and a second custom floating-point adder/subtractor circuit, wherein the first and the second custom floating-point adder/subtractor circuits have a same structure, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

In an embodiment, a processor includes: a central processing unit (CPU); and a digital signal processing (DSP) circuit coupled to the CPU, wherein the CPU and DSP circuit are integrated in a same semiconductor die, wherein the DSP circuit comprises a floating-point CORDIC circuit for computing sine and cosine functions iteratively in multiple iterations, wherein the floating-point CORDIC circuit comprises: a counter configured to be incremented by one after each iteration; an angle updating circuit configured to be initialized with an initial value for an angle and configured to compute, for each iteration, an updated value for the angle based on a current value of the angle and a pre-determined rotation angle for each iteration; and a coordinate updating circuit comprising: a first register for storing a floating-point value corresponding to the cosine function; a second register for storing a floating-point value corresponding to the sine function; a first custom floating-point adder/subtractor circuit; and a second custom floating-point adder/subtractor circuit having a same structure as the first custom floating-point adder/subtractor circuit, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

In an embodiment, an electrical system includes: a processor comprising: a central processing unit (CPU); and a digital signal processing (DSP) circuit coupled to the CPU, wherein the CPU and DSP circuit are integrated in a same semiconductor die, wherein the DSP circuit comprises a floating-point CORDIC circuit configured to convert a vector in a polar coordinate system into coordinates in a Cartesian coordinate system by operating the floating-point CORDIC circuit in multiple iterations of operation, wherein the floating-point CORDIC circuit comprises: a counter configured to be incremented by one after each iteration; an angle updating circuit configured to be initialized with an initial value for an angle and configured to compute, for each iteration, an updated value for the angle based on a current value of the angle and a pre-determined rotation angle for each iteration; and a coordinate updating circuit comprising: a first register for storing a first floating-point value corresponding to an X-coordinate in the Cartesian coordinate system; a second register for storing a second floating-point value corresponding to a Y-coordinate in the Cartesian coordinate system; a first custom floating-point adder/subtractor circuit, wherein the first custom floating-point adder/subtractor circuit is configured to, for each iteration, calculate an updated value for the first floating-point value by computing a difference between the first floating-point value and a scaled version of the second floating-point value, wherein the scaled version of the second floating-point value is a product of a sign of the current value of the angle and the second floating-point value divided by 2ⁱ, wherein i is an output of the counter, wherein the first custom floating-point adder/subtractor circuit is configured to compute the second floating-point value divided by 2ⁱ by subtracting i from an exponent of the second floating-point value; and a second custom floating-point adder/subtractor circuit, wherein the second custom floating-point adder/subtractor circuit is configured to, for each iteration, calculate an updated value for the second floating-point value by computing a sum of the second floating-point value and a scaled version of the first floating-point value, wherein the scaled version of the first floating-point value is a product of the sign of the current value of the angle and the first floating-point value divided by 2ⁱ, wherein the second custom floating-point adder/subtractor circuit is configured to compute the first floating-point value divided by 2ⁱ by subtracting i from an exponent of the first floating-point value. The electrical system further includes: a load coupled to the processor; a control path between the processor and load, wherein the control path is configured to send control signals from the processor to the load; and a feedback path between the load and the processor, wherein the feedback path is configured to send feedback signals from the load to the processor.

### BRIEF DESCRIPTION OF THE DRAWINGS

The details of one or more embodiments of the invention are set forth in the accompanying drawings and the description below. Other features, objects, and advantages of the invention will be apparent from the description and drawings, and from the claims. In the figures, the same or similar reference symbols generally designate the same or similar component parts throughout the various figures, which will generally not be re-described in the interest of brevity. For a more complete understanding of the invention, reference is now made to the following descriptions taken in conjunction with the accompanying drawings, in which:

FIG. 1 illustrates an electrical system comprising a processor and a load, in an embodiment;

FIG. 2 illustrates a block diagram of a circuit for implementing the CORDIC algorithm, in an embodiment;

FIG. 3 illustrates details of a first portion of the circuit of FIG. 2, in an embodiment;

FIG. 4 illustrates details of a second portion of the circuit of FIG. 2, in an embodiment;

FIG. 5 illustrates a binary representation of a floating-point number, in an embodiment;

FIG. 6 illustrates a block diagram of a custom floating-point adder/subtractor circuit, in an embodiment;

FIG. 7 illustrates a block diagram of a circuit for implementing the CORDIC algorithm, in another embodiment;

FIG. 8 illustrates details of a first portion of the circuit of FIG. 7, in an embodiment; and

FIG. 9 illustrates details of a second portion of the circuit of FIG. 7, in an embodiment.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described in the context of circuits for implementing the CORDIC algorithm and processors with support for floating-point CORDIC function.

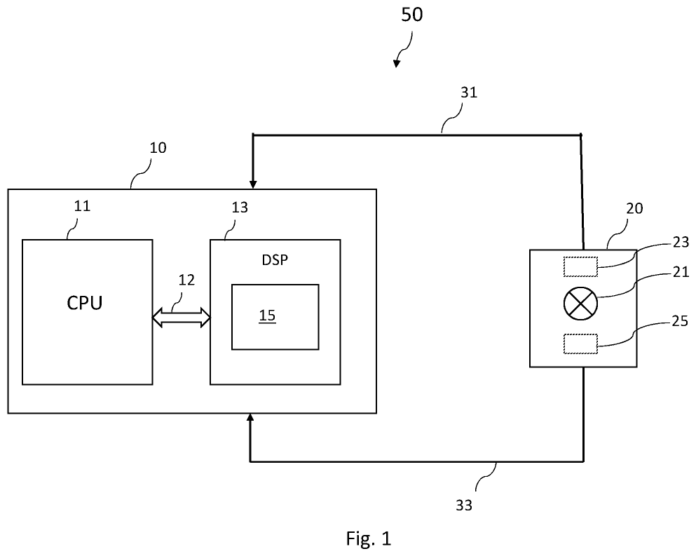

FIG. 1 illustrates an electrical system 50 comprising a processor 10 and a load 20, in an embodiment. In the illustrated embodiment, the processor 10 includes a processor core 11, such as a central processing unit (CPU), which may be, e.g., an Advanced RISC Machines (ARM) core. The processor 10 also includes an integrated (e.g., integrated on a same monolithic semiconductor die with the processor core 11) digital signal processing (DSP) circuit 13. The DSP circuit 13 is coupled to the processor core 11 through a signal path 12 (which may include a plurality of signal lines) and provides support for various signal processing functions. In the example of FIG. 1, the DSP circuit 13 includes a circuit 15 for implementing the CORDIC algorithm for floating-point numbers. In other words, the circuit 15 performs floating-point calculation to calculate the CORDIC function (e.g., the cosine and the sine functions) for a use-specified angle, in some embodiments. For ease of discussion, the circuit 15 for implementing the CORDIC algorithm is also referred to as a CORDIC circuit 15 herein. Various embodiments (e.g., 100, 100A) of the CORDIC circuit 15 are discussed below.

In the example of FIG. 1, the electrical system 50 further includes the load 20, which may be, e.g., a motor system 20. The motor system 20 may include a motor 21, a driving circuit 23 for driving the motor 21, and a sensor 25 for sensing the position (e.g., relative position between the stator and the rotor of the motor 21) of the motor 21. The processor 10 may run a motor control algorithm used for controlling the operation of the motor system 20. The DSP circuit 13 may perform certain signal processing functions used by the motor control algorithm (e.g., computing CORDIC function). The control signals generated by the processor 10 are sent from the processor 10 to the motor system 20 through a control path 31 (which may include a plurality of signal lines) coupled between the processor 10 and the motor system 20. The driving circuit 23 receives the control signals, performs suitable operations such as signal amplification, signal filtering, and voltage/current level shifting, and generates the appropriate signals for driving the motor 21. The sensor 25 senses the position of the motor 21, and sends back feedback information (e.g., position of the motor 21) to the processor 10 through a feedback path 33 (which may include a plurality of signal lines) coupled between the processor 10 and the motor system 20.

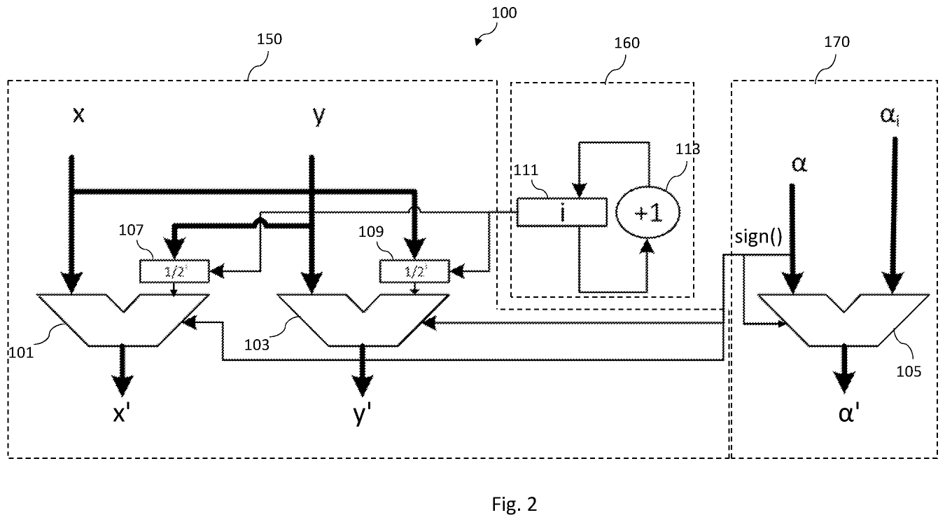

FIG. 2 illustrates a block diagram of a circuit 100 for implementing the CORDIC algorithm, in an embodiment. The circuit 100 (also referred to as a CORDIC circuit 100) includes a counter circuit 160, an angle updating circuit 170, and a coordinate updating circuit 150. Note that for simplicity, not all details of the CORDIC circuit 100 are illustrated in FIG. 2. The CORDIC algorithm is an iterative algorithm for converting a vector in a polar coordinate system into an x-coordinate and a y-coordinate in the Cartesian coordinate system, or for computing the cosine and sine (which corresponds to the x-coordinate and the y-coordinate in the Cartesian coordinate system for a vector of unit length) of a user-specified angle. The CORDIC circuit 100 is designed to run iteratively (e.g., operate multiple times) to compute the CORDIC function. Discussion below use the example where the CORDIC circuit 100 is used to convert a vector with a length r and an angle α into an x-coordinate and a y-coordinate in a Cartesian coordinate system.

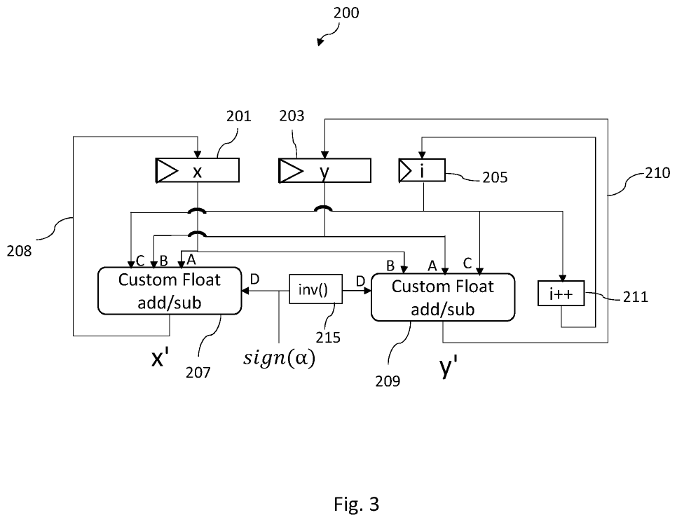

In some embodiments, to perform the CORDIC algorithm for a vector with a length r and an angle α, the CPU 11 (see FIG. 1) sends the vector length r and the angle α to the DSP circuit 13, which initializes the CORDIC circuit 100 by calling an initialization function Rot_Init(r,α), where α is the user-specified angle in a range between −π and π, and r>0 is the vector length. The initialization function sets the x-coordinate X (which corresponds r×cos(α)) and the y-coordinate Y (which corresponds to r×sin(α)) to initial values of r and o, respectively. The register 205 (see, e.g., FIG. 3) of the counter 160 is initialized with a value of zero by the initialization function, in some embodiments.

Next, the DSP circuit 13 (or the CORDIC circuit 100) performs a rectification process, which shifts (e.g., rotates) the angle α by π/2 or −π/2 to ensure that the shifted angle α falls within a convergence range between −A and A for the CORDIC algorithm. In other words, the angle α is shifted such that after being shifted, αΣ[−A,A], where A=Σ_{i≥0} arctan(½ⁱ)≈99°. In addition, the rectification process modifies the values for the x-coordinate X and the y-coordinate Y in accordance with the shifting of the angle α. Details are discussed below.

In some embodiments, during the rectification process, the sign of the angle α is checked. If the angle α is positive (e.g., α>0), the angle α is shifted by −π/2 (e.g., α=α−π/2), the x-coordinate X is assigned with an inverse of the initial value for the y-coordinate Y, and the y-coordinate Y is assigned the initial value for the x-coordinate X (e.g., (x,y)←(−y,x)). If, however, the angle α is negative (e.g., α<0), the angle α is shifted by π/2 (e.g., α=α+π/2), the x-coordinate X is assigned with the initial value for the y-coordinate Y, and the y-coordinate Y is assigned the inverse of the initial value for the x-coordinate X (e.g., (x,y)←(y,−x)). Note that in the discussion herein, an “inverse” of a number refers to an additive inverse number (e.g., a number with the same magnitude but opposite sign).

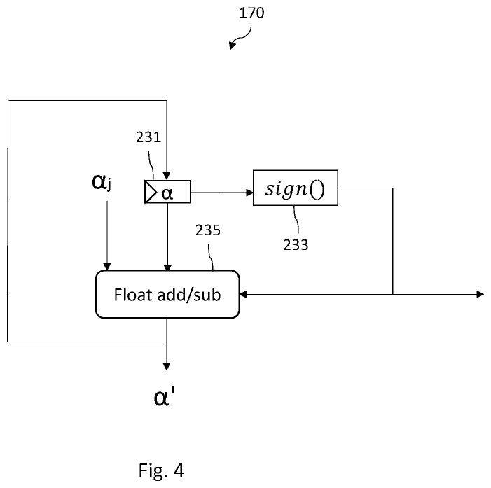

The angle α and the values (x,y) for the x-coordinate X and the y-coordinate Y obtained after the rectification process are used as the initial values for the iterative processing of the CORDIC circuit 100. In particular, the angle α obtained after the rectification process is used as the initialize value for the register 231 (see, e.g., FIG. 4) of the angle updating circuit 170. The x-coordinate X and the y-coordinate Y obtained after the rectification process are used as the initial values for the registers 201 and 203 (see, e.g., FIG. 3), respectively, of the coordinate updating circuit. More details are discussed hereinafter.

In some embodiments, after the rectification process, the DSP circuit 13 executes an iteration function Rot_Iter( ) multiple times to update the x-coordinate X and the y-coordinate Y in multiple iterations. In other words, each time the iteration function Rot_Iter( ) is called, the CORDIC circuit 100 is operated once (also referred to as performing one iteration). The counter 160 is incremented by one after each iteration. The x-coordinate, the y-coordinate, and the angle α stored in registers (e.g., 201, 203, and 231) of the CORDIC circuit 100 are updated after each iteration. The iterative operation of the CORDIC circuit 100 is stopped when a pre-determined number of iterations (e.g., between 20 to 30 iterations, such as 24 iterations) have been performed, or when it is determined that the CORDIC algorithm has converged.

Different variations of the CORDIC algorithm exist. The discussion herein uses an example CORDIC algorithm where the CORDIC circuit 100, after the rectification process, adjusts (e.g., rotates) the angle α in each iteration in a clockwise or counter-clock wise direction, depending on the sign of the current value of the angle α, such that the angle α converges toward zero. When the iterations stop, the final values for the x-coordinate X and the y-coordinate Y (e.g., values stored in the registers 201 and 203) are the converted x-coordinate and y-coordinate in the Cartesian coordinate system, or are the computed values for the cosine and sine functions for the original user-specified angle α (e.g., when r=1).

In the illustrated embodiment, during the i-th iteration of the operation of the CORDIC circuit 100, where i=0, 1, 2, . . . , n−1, an updated value X′ for the x-coordinate X, an updated value Y′ for the y-coordinate Y, and an updated value α′ for the angle α are computed as:

$${X}^{′} = X - sign ( α ) \times 1 / {2}^{i} \times Y \qquad ( 1.1 )$$

$${Y}^{′} = Y + sign ( α ) \times 1 / {2}^{i} \times X \qquad ( 1.2 )$$

$${α}^{′} = α - sign ( α ) \times {α}_{i} \qquad ( 1.3 )$$

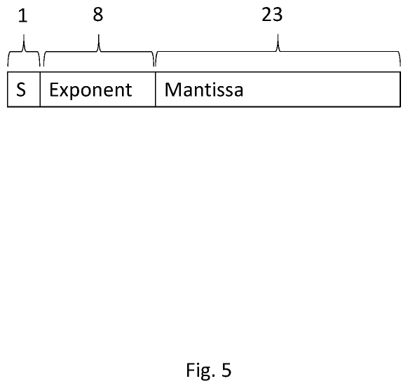

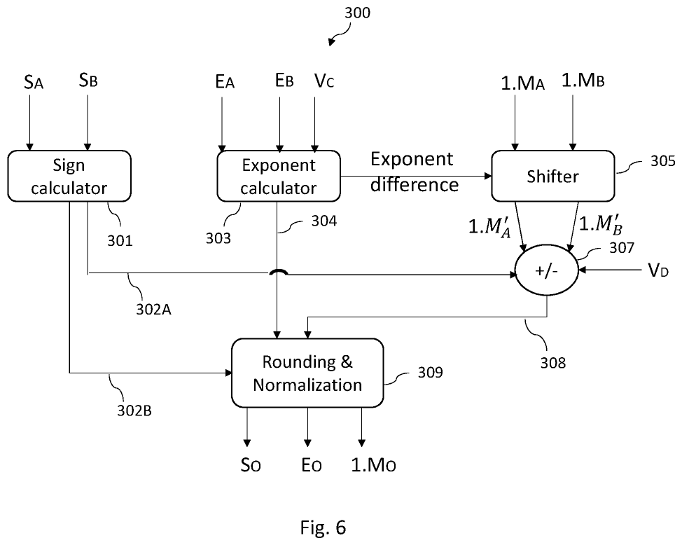

respectively, where sign(α) is the sign (e.g., having a value of +1 or −1) of the current value of the angle α, and αᵢ=arctan(2⁻¹). Note that the values for αᵢ are pre-computed and saved in a table in a memory region (e.g., non-volatile memory region) of the processor 10 for later use, and therefore, does not require extra computation. In Equations (1.1) and (1.2), the mathematical operation of dividing the floating-point number (e.g., X or Y) by 2ⁱ can be efficiently achieved by subtracting i from the exponent of the respective floating-point number, as discussed in more details hereinafter with reference to FIGS. 5 and 6. Note that the iteration index starts from zero, and therefore, when Equations (1.1)-(1.3) are used for the first time (i=0), the rotation angle αᵢ is 45 degrees (e.g., arctan(½°)=π/4, or equivalently, 45 degrees), and Equation (1.1) and (1.2) turn into X′=X−sign(α)×Y, and Y′=Y+sign(α)×X, respectively.

Skill artisan will readily appreciate that after a total of n iterations are performed, the computed x-coordinate and y-coordinate using Equations (1.1)-(1.3) should be multiplied with a scale factor K(n) to be mathematically accurate, where K(n) is given by:

$$K ( n ) = {\prod }_{i = 0}^{n - 1} \frac{1}{\sqrt{1 + {2}^{- 2 i}}} \qquad ( 1.4 )$$

The value for K(n) may also be pre-calculated and stored for later use. For simplicity, some implementation of the CORDIC algorithm may skip the multiplication with K(n), which may results in a gain factor of A=1/K(n) in the computed x-coordinate and y-coordinate. Note that when n is sufficiently large (e.g., n>20), the gain factor A approaches a constant value of about 1.647.

Still referring to FIG. 2, the counter 160 of the CORDIC circuit 100 includes a register 111 and an adder 113. The register 111 is initialized with a value of zero, and is incremented by 1 by the adder 113 after each iteration. The output of the counter 160 is the index i of each iteration (also referred to as iteration index). Therefore, the iteration index i starts from zero and is increased by one after each iteration, in some embodiments.

The angle updating circuit 170 computes, for each iteration, an updated value α′ for the angle α based on the current value of the angle α and a pre-determined rotation angle αᵢ, as shown in Equation (1.3) above. An arithmetic logic unit (ALU) 105 of the angle updating circuit 170 is used to compute the updated value α′ for the angle α. The ALU 105 may comprises a conventional floating-pointer adder known and used in art.

The coordinate updating circuit 150 includes two ALUs 101 and 103. The ALU 101 is used to compute the updated value X′ for the x-coordinate X, and the ALU 103 is used to compute the updated value Y′ for the y-coordinate Y. Note that as will be discussed in more details hereinafter, the ALUs 101 and 103 may comprise custom floating-point adder/subtractor circuits (see, e.g., 207 and 209 in FIG. 3) that are custom designed for efficient implementation the mathematical operation of Equations (1.1) and (1.2) for floating-point numbers. The output of the counter 160 and the sign of the current value of the angle α are sent to the ALUs 101 and 103 and used in the computation of the updated value X′ for the x-coordinate X and the updated value Y′ for the y-coordinate Y. The updated value X′, the updated value Y′, and the updated value α′ are used to update the values stored in, e.g., register 201, 203, and 231, respectively, after each iteration. The feedback path between the output terminals of the ALUs 101, 103, and 105 and the corresponding input terminals of the register 201, 203, and 231 are not illustrated in FIG. 2, but illustrated in FIGS. 3 and 4.

Note that FIG. 2 illustrates the high-level functional processing of the CORDIC circuit 100, and therefore, shows scaling circuits 107 and 109 that each scales an input value by a scale factor of ½ⁱ, where i is the output of the counter 160 and indicates the iteration index. The scaling circuits 107 and 109 are shown to illustrate the mathematic operation performed by the coordinate updating circuit 150. As will be discussed in details hereinafter, the actual implementation of the coordinate updating circuit 150 does not need explicit computation of the scale factor ½ⁱ, and the scaling operation is implemented efficiently in the custom floating-point adder/subtractor circuits 207 and 209 by subtracting i from the exponent of a respective floating-point number, and no multiplication is needed.

FIG. 3 illustrates a block diagram of a circuit 200. The circuit 200 is an implementation of the counter 160 and the coordinate updating circuit 150 of FIG. 2, in the illustrated embodiment. In other words, the circuit 200 may be used as the counter 160 and the coordinate updating circuit 150 of FIG. 2. In FIG. 3, the register 205 and the adder 211 correspond to the register 111 and the adder 113 of FIG. 2, respectively, and form the counter 160. The register 205 is initialized to zero, and is incremented by 1 after each iteration, in some embodiments. The output of the register 205 is the iteration index i.

In FIG. 3, the registers 201 and 203, the custom floating-point adder/subtractor circuits 207 and 209, and the inverter 215 form the coordinate updating circuit 150. The registers 201 and 203 are used to store the floating-point values that correspond to the x-coordinate X (e.g., cosine function value) and the y-coordinate Y (e.g., sine function value), respectively. The custom floating-point adder/subtractor circuits 207 and 209 have a same structure as illustrated in FIG. 6. Each of the custom floating-point adder/subtractor circuits 207 and 209 has four input terminals A, B, C, and D.

As illustrated in FIG. 3, the input terminals A, B, and C of the custom floating-point adder/subtractor circuit 207 are coupled to the output terminal of the register 201, the output terminal of the register 203, and the output terminal of the counter 160 (which is also the output terminal of the register 205), respectively. The input terminal D of the custom floating-point adder/subtractor circuit 207 is coupled to the sign bit of the current value of the angle α (which angle α is the value stored in, e.g., register 231 of the angle updating circuit 170 in FIG. 4) in some embodiments, and is illustrated as being supplied with a sign value sign(α) of the current value of the angle α.

The input terminals A, B, and C of the custom floating-point adder/subtractor circuit 209 are coupled to the output terminal of the register 203, the output terminal of the register 201, and the output terminal of the counter 160, respectively. The input terminal D of the custom floating-point adder/subtractor circuit 209 is coupled to the inverted sign bit of the current value of the angle α, in some embodiments, and is illustrated as being supplied with an inverse of the sign value sign(α) of the current value of the angle α, where the inverse of the sign value sign(α) is generated by an inverter 215.

In some embodiments, a floating-point number represented in binary format has a sign bit of zero when it has a positive value, and has a sign bit of one when it has a negative value. In the discussion herein, a positive floating-point number (e.g., with a sign bit of zero) is said to have a sign value of +1 (also referred to as a positive sign value), and a negative floating-point number (e.g., with a sign bit of one) is said to have a sign value of −1 (also referred to as a negative sign value). In other words, a sign bit of zero corresponds to a sign value of +1, and a sign bit of one corresponds to a sign value of −1. For ease of discussion, the discussion and the drawings herein may use the signal sign(α) to indicate the use the sign bit of the value α, with the understanding that in actual hardware implementation, the signal sign(α) (which has a value of +1 or −1) may be simply replaced by a connection to the sign bit (which has a value of zero or one), due to the one-to-one correspondence between the sign bit and the sign value. Therefore, the inverter 215 in FIG. 3 may be functionally interpreted as a scale factor of −1 for the sign value sign(α), and in hardware implementation, may be a logic inverter (e.g., a NOT gate) that flips the sign bit. In all of the mathematical equations herein, the sign value sign(α) is understood to have a value of +1 or −1.

Note that in FIG. 3, the output of the register 201 is coupled to input terminal A of the custom floating-point adder/subtractor circuit 207, but is coupled to input terminal B of the custom floating-point adder/subtractor circuit 209. Similarly, the output of the register 203 is coupled to input terminal B of the custom floating-point adder/subtractor circuit 207, but is coupled to input terminal A of the custom floating-point adder/subtractor circuit 209. In addition, the input terminal D of the custom floating-point adder/subtractor circuit 207 is coupled to the signal sign(α) (e.g., having value of +1 or −1), but the input terminal D of the custom floating-point adder/subtractor circuit 209 is coupled to the inverse of the signal sign(α). Such connections allow the same custom designed floating-point adder/subtractor circuit (see 300 in FIG. 6) to be used for both custom floating-point adder/subtractor circuits 207 and 209, thereby simplifying hardware design. In particular, the custom floating-point adder/subtractor circuit 300 of FIG. 6 implements the following function:

$${V}_{O} = {V}_{A} - {V}_{D} \times 1 / {2}^{{V}_{C}} \times {V}_{B} \qquad ( 2 )$$

where V_{A}, V_{B}, V_{C}, and V_{D} are the values of the signals applied at the input terminals A, B, C, and D of the custom floating-point adder/subtractor circuit, respectively, and V_{O} is the floating-point output value.

FIG. 4 illustrates a block diagram for the angle updating circuit 170 of FIG. 2, in an embodiment. The block diagram in FIG. 4 shows more details of the angle updating circuit 170. As illustrated in FIG. 4, the angle updating circuit 170 includes the register 231 for storing the current value of the angle α. The updated value α′ for the angle α is computed in accordance with Equation (1.3). The signal sign(α) of the current value of the angle α is used to determine whether the pre-determined rotation angle at is added to or subtracted from the current value of the angle α. The floating-point adder/subtractor circuit 235 is a conventional floating-point adder/subtractor that computes the sum or the difference of two input floating-point values, depending on the signal sign(α). The signal sign(α) is also sent to the coordinate updating circuit 150 as an input signal.

FIG. 5 illustrates a binary representation of a floating-point number, in an embodiment. In the example of FIG. 5, a floating-point number in binary format includes a sign bit S, an exponent, and a mantissa (may also be referred to as a significand). For example, a 32-bit floating-point number may include one sign bit S, an 8-bit exponent (which represents an integer value E for the exponent), and a 23-bit mantissa (which represents a fractional value M). In some embodiments, e.g., in IEEE-754 standard, it is customary for a normal floating-point number representation to assume an implicit bit of 1 as the most significant bit (MSB). In other words, a bit 1 is implicitly assumed as the integer bit before the decimal point, and the mantissa represents the fractional bits after the decimal point. A normal floating-point number is a floating-point number whose exponent is not null. A floating-point number is referred to as a subnormal (or denormal) floating-point number if the exponent is null (which corresponds to a very small floating-point number of, e.g., about 10-44 for IEEE-754 standard). For simplicity, a subnormal floating point number may be treated as zero, or may be disregarded for implementation. The discussion here focuses on normal floating-point numbers.

In the example of FIG. 5, the 23-bit and the implicit bit of 1 form a 24-bit mantissa with a fractional value M. The magnitude of the floating-point number is M×2^{E}, and the sign bit S determines the sign of the floating-point value. The number of bits illustrated in FIG. 5 is merely a non-limiting example, any suitable numbers of bits may be used to represent a floating-point number. Note that the “divide by 2ⁱ” operation in Equations (1.1) and (1.2) may be efficiently implemented for a floating-point number by subtracting i from the exponent of the floating-point number. This observation is used in the design of the custom floating-point adder/subtractor circuit 300 of FIG. 6. More details of “subtracting i from the exponent of the floating-point number” are discussed below with reference to Equation (3).

FIG. 6 illustrates a block diagram of a custom floating-point adder/subtractor circuit 300, in an embodiment. The custom floating-point adder/subtractor circuit 300 may be used as the custom floating-point adder/subtractor circuits 207 and 209 in FIG. 3. The floating-point adder/subtractor circuit 300 includes a sign calculator 301, an exponent calculator 303, a shifter 305, an adder/subtractor 307, and a rounding and normalization circuit 309.

Recall that the floating-point adder/subtractor circuit 300 is custom designed to implement the calculation of V_{O}=V_{A}−V_{D}×½^{V}^{_{C}}×V_{B}, where V_{A}, V_{B}, V_{C}, and V_{D} are the values of the signals applied at the input terminals A, B, C, and D of the custom floating-point adder/subtractor circuit, respectively, and V_{O} is the floating-point output value. In FIG. 6, the notations S_{A}, E_{A}, and M_{A} are used to represent the sign bit, the exponent, and the mantissa of the floating-point value V_{A}, respectively. In addition, the notation of 1.M_{A} is used to indicate the fractional value represented by the mantissa bits and the implicit bit of 1 for the mantissa. Similar notations are used for the floating-point values V_{B} and V_{O}. Note that the value V_{C} (which represents the iteration index i) may be an integer, and the value V_{D} is the sign value sign(α) (e.g., having a value of +1 or −1 in Equation (2) for understanding the mathematical computation, but may be replaced by the sign bit of a in hardware implementation). FIG. 6 does not explicitly show the input value V_{A} and V_{B}, with the understanding that the sign bit, the exponent, and the mantissa of V_{A} (or V_{B}) together represent the input value V_{A} (or V_{B}).

In FIG. 6, the exponent calculator 303 calculates an exponent difference E_{DIFF} as follows:

$${E}_{DIFF} = {E}_{A} - ( {E}_{B} - {V}_{C} ) \qquad ( 3 )$$

Note that the value E_{B}−V_{c} represents the exponent of the floating-point value ½^{V}^{_{C}}×V_{B}, or the exponent of V_{B}/2ⁱ, where i is the iteration index. Therefore, the sign of the exponent difference E_{DIFF} indicates whether V_{A} or V_{B}/2ⁱ has a larger exponent. The exponent difference E_{DIFF} is sent to the shifter 305 to determine which mantissa value, 1.M_{A} or 1.M_{B}, is shifted by the shifter 305. In some embodiments, the exponent E of the floating-point number has a positive offset (e.g., +127 for an 8-bit exponent E in IEEE-754 standard), such that a normal floating-point number has a non-negative exponent E. Therefore, if the calculation of E_{B}−V_{c} in Equation (3) results in a negative number, this indicates that the calculation of V_{B}/2ⁱ results in a subnormal floating-point number, in which case the value corresponding to V_{B}/2ⁱ may be assigned a zero value to simplify implementation.

In some embodiments, if the exponent difference E_{DIFF} is positive, the floating-point value V_{A} has a larger exponent E_{A} (which exponent E_{A} is used as the tentative exponent 304 for the output value), and in response, the shifter 305 shifts the mantissa value 1.M_{B} to the right-hand side by a total of E_{DIFF} bits (which is equivalent to dividing the mantissa value 1.M_{B} by 2^{E}^{_{DIFF}}) to generate an output value 1.M_{B}, and the mantissa value 1.M_{A} is passed through (e.g., unchanged) to generate an output value 1.M′_{A}. Conversely, if the exponent difference E_{DIFF} is negative, the exponent E_{B}−V_{c} is larger (which exponent E_{B}−V_{c} is used as the tentative exponent 304 of the output value), and in response, the shifter 305 shifts the mantissa value 1.M_{A} to the right-hand side by a total of −E_{DIFF} bits (which is equivalent to dividing the mantissa value 1.M_{A} by 2^{-E}^{_{DIFF}}) to generate the output value 1.M′_{A}, and the mantissa 1.M_{B} is passed through (e.g., unchanged) to generate the output value 1.M_{B}.

Still referring to FIG. 6, depending on the value V_{D}, the adder/subtractor 307 calculates a sum of (e.g., when the value V_{D} is −1), or a difference between (e.g., when the value V_{D} is +1), a first value and a second value, where the first value has a sign determined by (e.g., equal to) the sign bit S_{A} and has a magnitude determined by (e.g., equal to) the mantissa value 1.M′_{A}, and the second value has a sign determined by (e.g., equal to) the sign bit S_{B} and has a magnitude determined by (e.g., equal to) the mantissa value 1.M_{B}. The sign bits S_{A} and S_{B} may be sent from (e.g., bypassed by) the sign calculator 301 to the adder/subtractor 307 through a signal path 302A. In some embodiments, the adder/subtractor 307 may be or include an integer adder/subtractor. The adder/subtractor 307 may use more bits (e.g., two more bits) than the number of bits in the first value and the second value, in order to keep two shifted-out bits as a guard (G) bit and a round (R) bit. The processing regarding the guard bit and round bit is the same as or similar to that of a conventional floating-point adder/subtractor, thus details are not discussed here. The output 308 of the adder/subtractor 307 is sent to the rounding and normalization circuit 309.

The rounding and normalization circuit 309 receives the tentative exponent 304 from the exponent calculator, the output 308 of the adder/subtractor 307, and an output of the sign calculator 301 (e.g., through signal path 302B), and based on those inputs, determines the sign bit S_{O}, the exponent E_{O}, and the mantissa value 1.M_{O} for the output value V_{O}. In some embodiments, the sign calculator 301 performs a logic XOR operation of the sign bits S_{A} and S_{B}, and sends the output of the XOR operation to the rounding and normalization circuit 309 through the signal path 302B. In some embodiments, the sign calculator 301 is omitted, and the XOR operation may be performed by the rounding and normalization circuit 309.

In some embodiments, the rounding and normalization circuit 309 checks for leading zeros in the output 308 of the adder/subtractor 307, and in response to detecting leading zeros, shift the output 308 to the left-hand side for a number of bits to remove the leading zeros and adjust (e.g., reduce) the tentative exponent 304 by a corresponding number. The rounding and normalization circuit 309 may also take care of rounding, carry bit, or the like. The processing regarding the rounding, carry bit, or the like is the same as or similar to that of a conventional floating-point adder/subtractor, thus details are not discussed here. Note that by setting the input signal V_{C} to zero, the custom floating-point adder/subtractor circuit 300 could function in the same way as a conventional floating-point adder/subtractor.

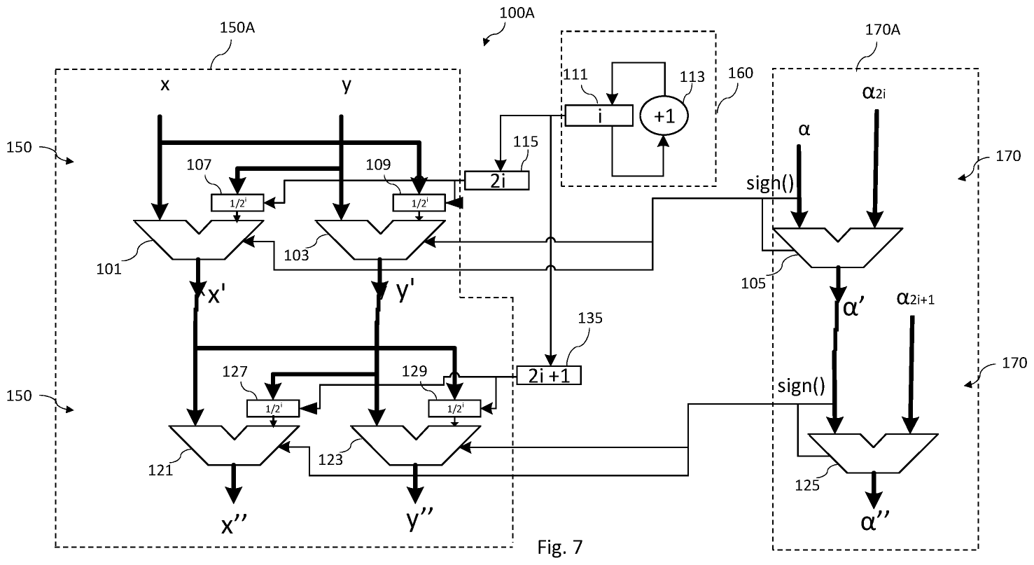

FIG. 7 illustrates a block diagram of a CORDIC circuit 100A, in another embodiment. The CORDIC circuit 100A includes a coordinate updating circuit 150A, an angle updating circuit 170A, and a counter 160. The coordinate updating circuit 150A includes two copies of the coordinate updating circuit 150 of FIG. 2 coupled in cascade, with the output terminals (labeled as X′ and Y′) of a first one of the coordinate updating circuits 150 connected to the input terminals of the second one of the coordinate updating circuits 150. The output terminals of the second one of the coordinate updating circuits 150 are labeled as X″ and Y″.

The counter 160 in FIG. 7 is the same as the counter 160 of FIG. 2, and is initialized to zero and is incremented by one after each iteration. Denote the output of the counter 160 (which is the iteration index) as i, then the value 2i and 2i+1 are sent to the first one and the second one of the coordinate updating circuits 150, respectively.

The angle updating circuit 170A includes two copies of the angle updating circuit 170 of FIG. 2 coupled in cascade, with the output terminal (labeled as α′) of a first one of the angle updating circuits 170 connected to the input terminal of the second one of the angle updating circuits 170. The output terminal of the second one of the angle updating circuits 170 is labeled as α″.

One skilled in the art will readily appreciate that each time the CORDIC circuit 100A is operated, it effectively performs the processing achieved by two iterations of the CORDIC circuit 100. In other words, each iteration of the CORDIC circuit 100A performs the processing achieved by two iterations of the CORDIC circuit 100. Therefore, in the illustrated embodiments, the CORDIC circuit 100A is able to perform two iterations of the CORDIC algorithm in one processor cycle, which greatly reduces the time required to compute the CORDIC function.

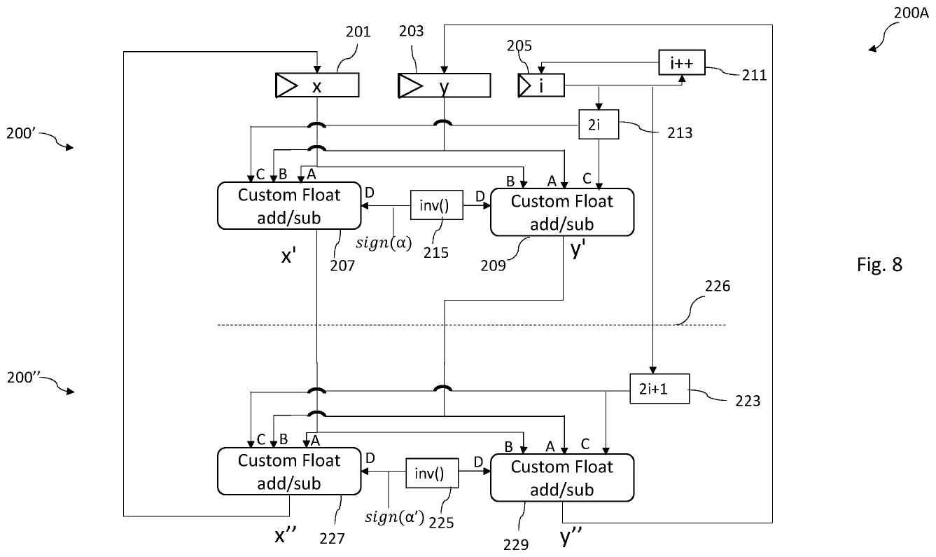

FIG. 8 illustrates a block diagram of a circuit 200A, in an embodiment. The circuit 200A shows implementation details of the counter 160 and the coordinate updating circuit 150A of FIG. 7. The top portion (e.g., above the dashed line 226) of the circuit 200A, denoted as circuit 200′, is similar to the circuit 200 of FIG. 3, but includes a circuit 213 that doubles the output of the register 205. The output of the circuit 213 (e.g., 2i) is sent to the terminals C of the custom floating-point adder/subtractor circuits 207 and 209. The lower portion (e.g., below the dashed line 226) of the circuit 200A, denoted as circuit 200″, is similar to the circuit 200 of FIG. 3, but with the registers 201/203 and the counter 160 removed. In addition, a circuit 223 computes a value of 2i+1 (where i is the output of the register 205). The output of the circuit 223 is sent to the terminals C of the custom floating-point adder/subtractor circuits 227 and 229. The custom floating-point adder/subtractor circuits 227 and 229 have the same structure as illustrated in FIG. 6. The output terminals (labeled as X′ and Y′) of circuit 200′ are connected to input terminals of the circuit 200″.

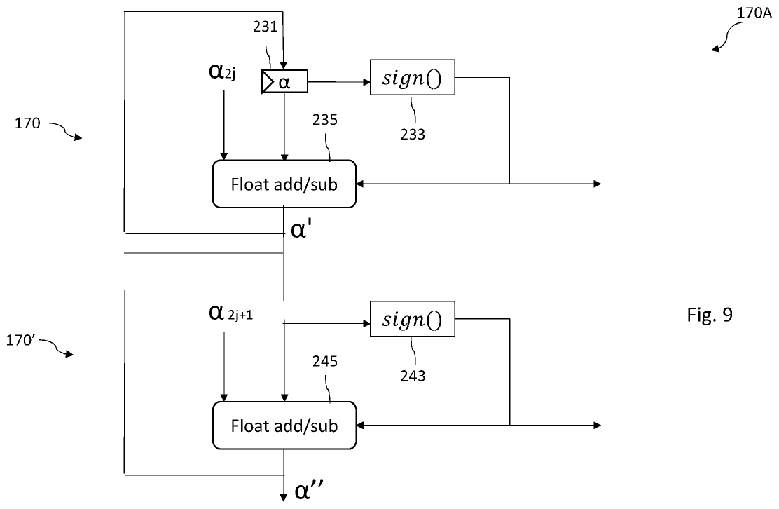

FIG. 9 illustrates a block diagram for the circuit 170A, in an embodiment. The circuit 107A shows implementation details of the angle updating circuit 170A of FIG. 7. The circuit 170A includes the angle updating circuit 170 of FIG. 4 coupled in cascade with a circuit 170′, with the output terminal (labeled as α′) of the angle updating circuit 170 connected to the input terminal of the circuit 170′. The circuit 170′ is similar to the circuit 170, but with the register 231 removed.

Disclosed embodiments may achieve advantages. For example, the various disclosed CORDIC circuits (e.g., 100, 100A) implement floating-point CORDIC algorithm. The mathematical operation of “dividing by 2ⁱ” is efficiently performed by subtracting i from the exponent of a respective floating-point number. The disclosed CORDIC circuits may be integrated into a same semiconductor die with a CPU to form a processor that provides support for direct floating-point CORDIC function computation. Compared with a reference design where the CORDIC circuit is outside the processor (e.g., as a co-processor) and designed for integer number operations only, the disclosed embodiments reduce overhead related with communication between the processor and the external CORDIC circuit. Furthermore, efficiency is improved compared with the reference design, because the disclosed CORDIC circuits can perform floating-point calculation directly without the need for the CPU to convert between floating-point number representation and integer number representation. As another example of the advantage, the CORDIC circuit 100A is able to perform two iterations of the CORDIC algorithm in one processor cycle, thereby reducing the time needed to compute the CORDIC function.

Example embodiments of the present invention are summarized here. Other embodiments can also be understood from the entirety of the specification and the claims filed herein.

Example 1. In an embodiment, a circuit for computing floating-point sine and cosine functions iteratively through multiple iterations includes: a counter configured to be incremented by one after each iteration; an angle updating circuit configured to be initialized with an initial value for an angle and configured to compute, for each iteration, an updated value of the angle based on a current value of the angle and a pre-determined rotation angle for each iteration; and a coordinate updating circuit comprising: a first register for storing a value corresponding to the cosine function; a second register for storing a value corresponding to the sine function; and a first custom floating-point adder/subtractor circuit and a second custom floating-point adder/subtractor circuit, wherein the first and the second custom floating-point adder/subtractor circuits have a same structure, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

Example 2. The circuit of Example 1, wherein the fourth input terminal of the first custom floating-point adder/subtractor circuit is configured to be supplied with a sign bit of the current value of the angle, and the fourth input terminal of the second custom floating-point adder/subtractor circuit is configured to be supplied with an inverse of the sign bit of the current value of the angle.

Example 3. The circuit of Example 2, wherein each of the first and the second custom floating-point adder/subtractor circuits is configured to compute, for each iteration, an output value that is equal to a difference between a first value and a scaled version of a second value, wherein the first value and the second value are signal values at the first input terminal and the second input terminal, respectively, of the respective first or second custom floating-point adder/subtractor circuit.

Example 4. The circuit of Example 3, wherein the scaled version of the second value is equal to the second value divided by 24 and multiplied by a scale factor of 1 or −1, wherein the scale factor is determined by a signal value supplied at the fourth input terminal of the respective first or second custom floating-point adder/subtractor circuit, wherein i is an output of the counter.

Example 5. The circuit of Example 3, wherein the first value and the second value are floating point numbers represented in binary format, wherein each of the first and the second custom floating-point adder/subtractor circuits comprises: an exponent calculator configured to compute an exponent difference, wherein the exponent difference is proportional to a value computed by subtracting an exponent of the second value and an output of the counter from an exponent of the first value; a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.

Example 6. The circuit of Example 5, wherein the exponent difference is computed by subtracting the exponent of the second value and the output of the counter from the exponent of the first value, wherein when the exponent difference has a positive value, the shifter circuit is configured to generate the first output value by passing through the first mantissa of the first value, and is configured to generate the second output value by shifting the second mantissa of the second value to the right-hand side by the number of bits indicated by the exponent difference.

Example 7. The circuit of Example 5, wherein when the value supplied at the fourth input terminal has a positive value, the add/subtractor circuit is configured to compute a difference between the third value and the fourth value.

Example 8. The circuit of Example 1, wherein the angle updating circuit is configured to compute, for each iteration, the updated value of the angle by subtracting, from the current value of the angle, a product of a sign of the current value of the angle and the pre-determined rotation angle for each iteration.

Example 9. The circuit of Example 8, wherein the pre-determined rotation angle for each iteration is arctan (2⁻ⁱ), wherein i is an output of the counter.

Example 10. The circuit of Example 9, wherein one of the first register and the second register is configured to be initialized to zero, and another one of the first register and the second register is configured to be initialized to a non-zero value.

Example 11. The circuit of Example 10, wherein the coordinate updating circuit further comprises: a first feedback path connecting an output terminal of the first custom floating-point adder/subtractor circuit to an input terminal of the first register; and a second feedback path connecting an output terminal of the second custom floating-point adder/subtractor circuit to an input terminal of the second register.

Example 12. In an embodiment, a processor includes: a central processing unit (CPU); and a digital signal processing (DSP) circuit coupled to the CPU, wherein the CPU and DSP circuit are integrated in a same semiconductor die, wherein the DSP circuit comprises a floating-point CORDIC circuit for computing sine and cosine functions iteratively in multiple iterations, wherein the floating-point CORDIC circuit comprises: a counter configured to be incremented by one after each iteration; an angle updating circuit configured to be initialized with an initial value for an angle and configured to compute, for each iteration, an updated value for the angle based on a current value of the angle and a pre-determined rotation angle for each iteration; and a coordinate updating circuit comprising: a first register for storing a floating-point value corresponding to the cosine function; a second register for storing a floating-point value corresponding to the sine function; a first custom floating-point adder/subtractor circuit; and a second custom floating-point adder/subtractor circuit having a same structure as the first custom floating-point adder/subtractor circuit, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

Example 13. The processor of Example 12, wherein the fourth input terminal of the first custom floating-point adder/subtractor circuit is coupled to a sign bit of the current value of the angle, and the fourth input terminal of the second custom floating-point adder/subtractor circuit is coupled to an inverse of the sign bit of the current value of the angle.

Example 14. The processor of Example 13, wherein the floating-point value stored in the first register and the floating-point value stored in the second register are represented in binary format, wherein each of the first and the second custom floating-point adder/subtractor circuits comprises: an exponent calculator configured to compute an exponent difference, wherein the exponent difference is proportional to a value computed by subtracting an exponent of a second value at the second input terminal and an output of the counter from an exponent of a first value at the first input terminal; a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.

Example 15. The processor of Example 12, wherein each of the first and the second custom floating-point adder/subtractor circuits is configured to compute, for each iteration, a sum of a first value and a scaled version of a second value, wherein the first value and the second value are signal values at the first input terminal and the second input terminal, respectively, of the respective first or second custom floating-point adder/subtractor circuit.

Example 16. The processor of Example 15, wherein the scaled version of the second value is the second value divided by 2 and multiplied by a scale factor of 1 or −1.

Example 17. In an embodiment, an electrical system includes: a processor comprising: a central processing unit (CPU); and a digital signal processing (DSP) circuit coupled to the CPU, wherein the CPU and DSP circuit are integrated in a same semiconductor die, wherein the DSP circuit comprises a floating-point CORDIC circuit configured to convert a vector in a polar coordinate system into coordinates in a Cartesian coordinate system by operating the floating-point CORDIC circuit in multiple iterations of operation, wherein the floating-point CORDIC circuit comprises: a counter configured to be incremented by one after each iteration; an angle updating circuit configured to be initialized with an initial value for an angle and configured to compute, for each iteration, an updated value for the angle based on a current value of the angle and a pre-determined rotation angle for each iteration; and a coordinate updating circuit comprising: a first register for storing a first floating-point value corresponding to an X-coordinate in the Cartesian coordinate system; a second register for storing a second floating-point value corresponding to a Y-coordinate in the Cartesian coordinate system; a first custom floating-point adder/subtractor circuit, wherein the first custom floating-point adder/subtractor circuit is configured to, for each iteration, calculate an updated value for the first floating-point value by computing a difference between the first floating-point value and a scaled version of the second floating-point value, wherein the scaled version of the second floating-point value is a product of a sign of the current value of the angle and the second floating-point value divided by 2ⁱ, wherein i is an output of the counter, wherein the first custom floating-point adder/subtractor circuit is configured to compute the second floating-point value divided by 2ⁱ by subtracting i from an exponent of the second floating-point value; and a second custom floating-point adder/subtractor circuit, wherein the second custom floating-point adder/subtractor circuit is configured to, for each iteration, calculate an updated value for the second floating-point value by computing a sum of the second floating-point value and a scaled version of the first floating-point value, wherein the scaled version of the first floating-point value is a product of the sign of the current value of the angle and the first floating-point value divided by 2ⁱ, wherein the second custom floating-point adder/subtractor circuit is configured to compute the first floating-point value divided by 2ⁱ by subtracting i from an exponent of the first floating-point value. The electrical system further includes: a load coupled to the processor; a control path between the processor and load, wherein the control path is configured to send control signals from the processor to the load; and a feedback path between the load and the processor, wherein the feedback path is configured to send feedback signals from the load to the processor.

Example 18. The electrical system of Example 17, wherein the load is an electrical motor system.

Example 19. The electrical system of Example 17, wherein the first and the second custom floating-point adder/subtractor circuits have a same structure, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively, wherein the fourth input terminal of the first custom floating-point adder/subtractor circuit is coupled to a sign bit of the current value of the angle, and the fourth input terminal of the second custom floating-point adder/subtractor circuit is coupled to an inverse of the sign bit of the current value of the angle.

Example 20. The electrical system of Example 19, wherein the first floating-point value and the second floating-point value are represented in binary format, wherein each of the first and the second custom floating-point adder/subtractor circuits comprises: an exponent calculator configured to compute an exponent difference, wherein the exponent difference is proportional to a value computed by subtracting an exponent of a second value at the second input terminal and the output of the counter from an exponent of a first value at the first input terminal; a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A circuit for computing floating-point sine and cosine functions iteratively through multiple iterations, the circuit comprising:
a counter configured to be incremented by one after each iteration;
an angle updating circuit configured to be initialized with an initial value for an angle and configured to compute, for each iteration, an updated value of the angle based on a current value of the angle and a pre-determined rotation angle for each iteration; and
a coordinate updating circuit comprising:
a first register for storing a value corresponding to the cosine function;
a second register for storing a value corresponding to the sine function; and
a first custom floating-point adder/subtractor circuit and a second custom floating-point adder/subtractor circuit, wherein the first and the second custom floating-point adder/subtractor circuits have a same structure, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

2. The circuit of claim 1, wherein the fourth input terminal of the first custom floating-point adder/subtractor circuit is configured to be supplied with a sign bit of the current value of the angle, and the fourth input terminal of the second custom floating-point adder/subtractor circuit is configured to be supplied with an inverse of the sign bit of the current value of the angle.

3. The circuit of claim 2, wherein each of the first and the second custom floating-point adder/subtractor circuits is configured to compute, for each iteration, an output value that is equal to a difference between a first value and a scaled version of a second value, wherein the first value and the second value are signal values at the first input terminal and the second input terminal, respectively, of the respective first or second custom floating-point adder/subtractor circuit.

4. The circuit of claim 3, wherein the scaled version of the second value is equal to the second value divided by 2ⁱ and multiplied by a scale factor of 1 or −1, wherein the scale factor is determined by a signal value supplied at the fourth input terminal of the respective first or second custom floating-point adder/subtractor circuit, wherein i is an output of the counter.

5. The circuit of claim 3, wherein the first value and the second value are floating point numbers represented in binary format, wherein each of the first and the second custom floating-point adder/subtractor circuits comprises:
an exponent calculator configured to compute an exponent difference, wherein the exponent difference is proportional to a value computed by subtracting an exponent of the second value and an output of the counter from an exponent of the first value;
a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and
an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.

6. The circuit of claim 5, wherein the exponent difference is computed by subtracting the exponent of the second value and the output of the counter from the exponent of the first value, wherein when the exponent difference has a positive value, the shifter circuit is configured to generate the first output value by passing through the first mantissa of the first value, and is configured to generate the second output value by shifting the second mantissa of the second value to the right-hand side by the number of bits indicated by the exponent difference.

7. The circuit of claim 5, wherein when the value supplied at the fourth input terminal has a positive value, the add/subtractor circuit is configured to compute a difference between the third value and the fourth value.

8. The circuit of claim 1, wherein the angle updating circuit is configured to compute, for each iteration, the updated value of the angle by subtracting, from the current value of the angle, a product of a sign of the current value of the angle and the pre-determined rotation angle for each iteration.

9. The circuit of claim 8, wherein the pre-determined rotation angle for each iteration is arctan (2⁻ⁱ), wherein i is an output of the counter.

10. The circuit of claim 9, wherein one of the first register and the second register is configured to be initialized to zero, and another one of the first register and the second register is configured to be initialized to a non-zero value.

11. The circuit of claim 10, wherein the coordinate updating circuit further comprises:
a first feedback path connecting an output terminal of the first custom floating-point adder/subtractor circuit to an input terminal of the first register; and
a second feedback path connecting an output terminal of the second custom floating-point adder/subtractor circuit to an input terminal of the second register.

12. A processor comprising:
a central processing unit (CPU); and
a digital signal processing (DSP) circuit coupled to the CPU, wherein the CPU and DSP circuit are integrated in a same semiconductor die, wherein the DSP circuit comprises a floating-point CORDIC circuit for computing sine and cosine functions iteratively in multiple iterations, wherein the floating-point CORDIC circuit comprises:
a counter configured to be incremented by one after each iteration;
an angle updating circuit configured to be initialized with an initial value for an angle and configured to compute, for each iteration, an updated value for the angle based on a current value of the angle and a pre-determined rotation angle for each iteration; and
a coordinate updating circuit comprising:
a first register for storing a floating-point value corresponding to the cosine function;
a second register for storing a floating-point value corresponding to the sine function;
a first custom floating-point adder/subtractor circuit; and
a second custom floating-point adder/subtractor circuit having a same structure as the first custom floating-point adder/subtractor circuit, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively.

13. The processor of claim 12, wherein the fourth input terminal of the first custom floating-point adder/subtractor circuit is coupled to a sign bit of the current value of the angle, and the fourth input terminal of the second custom floating-point adder/subtractor circuit is coupled to an inverse of the sign bit of the current value of the angle.

14. The processor of claim 13, wherein the floating-point value stored in the first register and the floating-point value stored in the second register are represented in binary format, wherein each of the first and the second custom floating-point adder/subtractor circuits comprises:
an exponent calculator configured to compute an exponent difference, wherein the exponent difference is proportional to a value computed by subtracting an exponent of a second value at the second input terminal and an output of the counter from an exponent of a first value at the first input terminal;
a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and
an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.

15. The processor of claim 12, wherein each of the first and the second custom floating-point adder/subtractor circuits is configured to compute, for each iteration, a sum of a first value and a scaled version of a second value, wherein the first value and the second value are signal values at the first input terminal and the second input terminal, respectively, of the respective first or second custom floating-point adder/subtractor circuit.

16. The processor of claim 15, wherein the scaled version of the second value is the second value divided by 2ⁱ and multiplied by a scale factor of 1 or −1.

17. An electrical system comprising:
a processor comprising:
a central processing unit (CPU); and
a digital signal processing (DSP) circuit coupled to the CPU, wherein the CPU and DSP circuit are integrated in a same semiconductor die, wherein the DSP circuit comprises a floating-point CORDIC circuit configured to convert a vector in a polar coordinate system into coordinates in a Cartesian coordinate system by operating the floating-point CORDIC circuit in multiple iterations of operation, wherein the floating-point CORDIC circuit comprises:
a counter configured to be incremented by one after each iteration;
an angle updating circuit configured to be initialized with an initial value for an angle and configured to compute, for each iteration, an updated value for the angle based on a current value of the angle and a pre-determined rotation angle for each iteration; and
a coordinate updating circuit comprising:
a first register for storing a first floating-point value corresponding to an X-coordinate in the Cartesian coordinate system;
a second register for storing a second floating-point value corresponding to a Y-coordinate in the Cartesian coordinate system;
a first custom floating-point adder/subtractor circuit, wherein the first custom floating-point adder/subtractor circuit is configured to, for each iteration, calculate an updated value for the first floating-point value by computing a difference between the first floating-point value and a scaled version of the second floating-point value, wherein the scaled version of the second floating-point value is a product of a sign of the current value of the angle and the second floating-point value divided by 2ⁱ, wherein i is an output of the counter, wherein the first custom floating-point adder/subtractor circuit is configured to compute the second floating-point value divided by 2ⁱ by subtracting i from an exponent of the second floating-point value; and
a second custom floating-point adder/subtractor circuit, wherein the second custom floating-point adder/subtractor circuit is configured to, for each iteration, calculate an updated value for the second floating-point value by computing a sum of the second floating-point value and a scaled version of the first floating-point value, wherein the scaled version of the first floating-point value is a product of the sign of the current value of the angle and the first floating-point value divided by 2ⁱ, wherein the second custom floating-point adder/subtractor circuit is configured to compute the first floating-point value divided by 2ⁱ by subtracting i from an exponent of the first floating-point value;
a load coupled to the processor;
a control path between the processor and load, wherein the control path is configured to send control signals from the processor to the load; and
a feedback path between the load and the processor, wherein the feedback path is configured to send feedback signals from the load to the processor.

18. The electrical system of claim 17, wherein the load is an electrical motor system.

19. The electrical system of claim 17, wherein the first and the second custom floating-point adder/subtractor circuits have a same structure, wherein each of the first and the second custom floating-point adder/subtractor circuits has a first input terminal, a second input terminal, a third input terminal, and a fourth input terminal, wherein the first input terminal, the second input terminal, and the third input terminal of the first custom floating-point adder/subtractor circuit are coupled to an output terminal of the first register, an output terminal of the second register, and an output terminal of the counter, respectively, and wherein the first input terminal, the second input terminal, and the third input terminal of the second custom floating-point adder/subtractor circuit are coupled to the output terminal of the second register, the output terminal of the first register, and the output terminal of the counter, respectively, wherein the fourth input terminal of the first custom floating-point adder/subtractor circuit is coupled to a sign bit of the current value of the angle, and the fourth input terminal of the second custom floating-point adder/subtractor circuit is coupled to an inverse of the sign bit of the current value of the angle.

20. The electrical system of claim 19, wherein the first floating-point value and the second floating-point value are represented in binary format, wherein each of the first and the second custom floating-point adder/subtractor circuits comprises:
an exponent calculator configured to compute an exponent difference, wherein the exponent difference is proportional to a value computed by subtracting an exponent of a second value at the second input terminal and the output of the counter from an exponent of a first value at the first input terminal;
a shifter circuit configured to, based on a sign of the exponent difference, generate a first output value by shifting a first mantissa of the first value by a number of bits indicated by the exponent difference or by passing through the first mantissa, and configured to generate a second output value by shifting a second mantissa of the second value by the number of bits indicated by the exponent difference or by passing through the second mantissa; and
an adder/subtractor circuit configured to compute, based on a value supplied at the fourth input terminal of the respective first or second custom floating-point adder/subtractor circuit, a sum or a difference of a third value and a fourth value, wherein the third value is formed by combining a first sign bit of the first value and the first output value, and the fourth value is formed by combining a second sign bit of the second value and the second output value.
